(19) United States
(12) Patent Application Publication
(10) Pub. No.: US 2024/0119204 A1
(43) Pub. Date: Apr. 11, 2024

(54) MODELING SIMULATION SYSTEM FOR PLASMA CONTROL

(71) Applicants: HEFEI INSTITUTES OF PHYSICAL SCIENCE, CHINESE ACADEMY OF SCIENCES, Hefei (CN); HUAZHONG UNIVERSITY OF SCIENCE AND TECHNOLOGY, Wuhan (CN)

(72) Inventors: Qiping YUAN, Hefei (CN); Heru GUO, Hefei (CN); Wei ZHENG, Wuhan (CN); Rui GAN, Wuhan (CN); Hengben MA, Wuhan (CN); Bingjia XIAO, Hefei (CN)

(73) Assignees: HEFEI INSTITUTES OF PHYSICAL SCIENCE, CHINESE ACADEMY OF SCIENCES, Hefei, CN (CN); HUAZHONG UNIVERSITY OF SCIENCE AND TECHNOLOGY, Wuhan, CN (CN)

(21) Appl. No.: 18/474,951

(22) Filed: Sep. 26, 2023

(30) Foreign Application Priority Data
Oct. 8, 2022 (CN) 202211222355.6

(51) Int. Cl. G06F 30/28

(52) U.S. Cl. CPC G06F 30/28

(57) ABSTRACT

Disclosed is a modeling simulation system for plasma control, comprising: an interactive modeling environment module and a parameter configuration component, configured to represent and construct a plasma control model and a response model; a simulation engine, configured to invoke a calculation code of a simulation element or perform a simulation calculation by using a solver, and transmit calculated simulation results back to users; a system library, comprising a basic library and a customization library; a device manager, configured to extend a communication interface by using a simulation element to support a communication between models and external systems and guarantee message synchronization.

### CROSS REFERENCE TO RELATED APPLICATION

The present application claims priority to Chinese Patent Application with No. 202211222355.6, entitled “Modeling Simulation System for Plasma Control”, and filed on Oct. 8, 2022, the content of which is expressly incorporated herein by reference in its entirety.

### TECHNICAL FIELD

The present disclosure relates to the field of plasma control, and particularly to a modeling simulation system for plasma control.

### BACKGROUND

Plasma discharge is a delicate and complex process that requires accurate control of plasma parameters such as the current, position, shape, kinetic curve, etc., to avoid damaging the tokamak device. In order to ensure the high performance and stable operation of the plasma, it is necessary to perform the discharge simulation before the discharge experiment to verify and optimize the discharge scheme and control algorithm, and to evaluate and test each subsystem. In order to further evaluate the performance of each system, the real subsystem needs to be connected to the simulation environment to perform the hardware-in-the-loop (HIL) simulation with the Tokamak model. The plasma control simulation platform (PCSSP) based on MATLAB/Simulink is a commonly used simulation tool for the plasma simulation, and has the characteristics of accuracy, flexibility and visualization. However, such simulation tool only supports the pure software simulation, and is difficult to consider connections to external systems and the HIL simulation based on hardware. However, the existing HIL simulation tools need to build a software model through Simulink and then to be connected to and debug a hardware interface. Therefore, the discharge simulation of the plasma requires more flexible visual simulation tools to support access to multiple real subsystems and access to operation codes of the high-performance plasma.

### SUMMARY

In order to solve the above-mentioned technical problem, the present disclosure provides a modeling simulation system for plasma control, which utilizes a combination of software and hardware to perform the model simulation by scheduling and solving a simulation element, and proposes a unified modeling interface, which can uniformly encapsulate a software model or a real system interface into a module to perform the simulation calculation in the system, accordingly the free docking of the real system and the software model can be implemented to perform the simulation. At the same time, the simulation verification platform customizes a model library that facilitates the plasma control, and customizes a database-related interface to support the historical data verification model.

The present disclosure provides a technical solution as follow: a modeling simulation system for plasma control, including: an interactive modeling environment module and a parameter configuration component, configured to represent and construct a plasma control model and a response model; a simulation engine, configured to invoke a calculation code of a simulation element or perform a simulation calculation by using a solver, and transmit calculated simulation results back to users; a system library, including a basic library and a customization library; a device manager, configured to extend a communication interface by using a simulation element to support a communication between models and external systems and guarantee message synchronization.

Furthermore, the interactive modeling environment module is constructed by visually dragging and connecting simulation elements, a user constructs a model graph by dragging and connecting modules from a model library view in the interactive modeling environment, the model graph is formed by combining and connecting a plurality of model blocks, and is stored as a file after the modeling is completed, and simulation parameters between the modules are stored in the file, including input/output ports, connection relationships, and nested relationships.

Furthermore, the parameter configuration component is configured to pre-read or pre-process the parameters, and write the processed parameters into a common data pool, the parameter configuration component is configured to provide a code editor and a code execution environment to support the writing and perform a parameter preprocessing code, and the obtained model configuration parameters are stored in the data pool in a form of a key-value pair; during the modeling, a user pre-defines a variable through the code editor and the execution environment and then enters a variable name according to a format; during the simulation, the simulation engine is configured to read the variable in the data pool through a shared memory to perform the simulation.

Furthermore, the simulation engine is configured to configure simulation information for the model including a simulation duration and a step, provide a solver for state space equations and system transfer functions in the model, control a simulation process, provide a message bus to support message passing among the engine, the model, and the block, and record simulation logs; the simulation engine is configured to perform a sort and an iterative operation according to a connection relationship of the simulation modules, and output simulation data.

Furthermore, the basic library is provided for basic operation and modeling, the customization library is a function library constructed for a tokamak device, and the customization library is configured to customize a control algorithm model, a data acquisition and processing model, an exception triggering and processing model for the plasma control, and integrate a device coil power supply model and a plasma response model.

Furthermore, the device manager is configured to store status information of each hardware device to ensure that one hardware device is invoked by only one interface module at the same time, and monitor a plurality of devices at the same time; the device manager is provided with a built-in channel wrapper to read mapping information between a channel and data of each hardware device; the file saves this mapping information by recording the channel number and signal name; when the connection of the hardware device changes, the device module is used only by modifying the definition of the file.

Furthermore, the device manager provides a simulation clock scheme, a clock signal is provided by the simulation platform and shared by all hardware devices, the clock signal is added by one for each cycle; when the simulation data is updated, the simulation clock is read by the external system at the same time; when the clock signal changes, the external system starts to enter a next cycle, to avoid data asynchronization.

Advantages are as follows:

The modeling simulation system for plasma control of the present disclosure can be flexibly extended to support a combination of software and hardware. The definition of the simulation element ensures the scalability of the framework, and the modules of each layer of the system framework are also designed around the simulation elements. Moreover, the customized extension can be performed based on the simulation elements, including a hardware closed-loop communication interface and a database interface.

### BRIEF DESCRIPTION OF THE DRAWINGS

FIG. 1 is a block diagram illustrating a modeling simulation system of the present disclosure.

FIG. 2 is a schematic diagram showing a modeling method based on an interactive modeling environment.

FIG. 3 is a schematic diagram of a modeling example of a simple plasma control model and a mapping rule thereof.

FIG. 4 is a flow chart of a simulation element at various simulation stages.

FIG. 5 is a schematic diagram of a variable PID control model with a filter.

FIG. 6 is a schematic diagram of a poloidal field coil current control model.

FIG. 7 is a schematic diagram of an RZIp control model.

FIG. 8 is a schematic diagram illustrating a hardware closed-loop communication interface.

FIG. 9 is a schematic diagram illustrating an interface to a database.

### DETAILED DESCRIPTION

The technical solution in the embodiments of the present disclosure will be clearly and completely described below with reference to accompanying drawings of the embodiments of the present disclosure. Obviously, the described embodiments are merely some embodiments of the present disclosure and not all the embodiments; and other embodiments obtained by one of ordinary skill in the art based on the embodiments of the present disclosure without any creative effort all fall within the protection scope of the present disclosure.

According to an embodiment of the present disclosure, a modeling simulation system for plasma control is provided, which is applied to plasma simulation verification, and designed to assist a plasma control system (PCS) to perform algorithm logic verification, system design verification, and discharge scheme verification by means of modeling and hardware closed-loop simulation. The system may include:

an interactive modeling environment module and a parameter configuration component, configured to represent and construct a plasma control model and a response model;

a simulation engine, configured to invoke a calculation code of a simulation element or perform a simulation calculation by using a solver, and transmit a calculated simulation result back to a user;

a system library, including a basic library and a customization library;

a device manager, configured to extend a communication interface by using a simulation element to support a communication between a model and an external system to guarantee message synchronization.

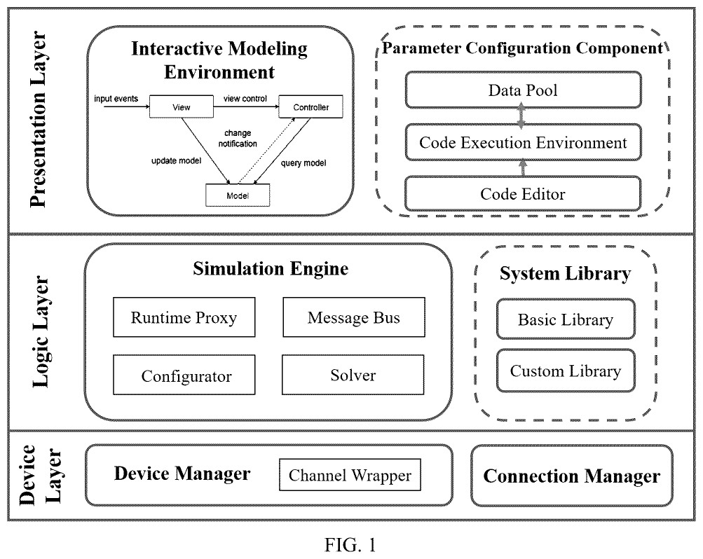

According to an embodiment of the present disclosure, a framework of the system is shown in FIG. 1. From a perspective of the system design, the framework is designed using a layered mechanism, and is mainly divided into a presentation layer, a logic layer, and a device layer from top to bottom.

In a visual, modular modeling process, the model may be regarded as a collection of computations, operations, and data channels. By defining a functional unit, the framework can implement various computations and signal operations, and thus is referred to as a simulation element. The definition thereof is described later. Accordingly, modeling in the framework can be regarded as building a model through these basic simulation elements, so that the framework simulates the model, which can be regarded as that each layer of the framework separately represents, organizes, and computes the simulation element.

The presentation layer provides a visual modeling interface and a parameter configuration component for simulation elements. The plasma control model and the response model may be represented and constructed at the presentation layer. The model constructed at the presentation layer may be analyzed at the logical layer, and the simulation engine may invoke a calculation code of simulation elements or use a solver or the like to perform the simulation calculation. The calculated simulation result may be transmitted back to the presentation layer for the user. Considering that the plasma control system is a complex real-time control system and the Tokamak experiment is very expensive, it is necessary to perform co-simulation of the control system and the model before the experiment. Therefore, the framework specifically includes a device layer, and provides a device manager which may expand a communication interface by using a simulation element to support communication between the model and an external system, such as a PCS, and guarantee the message synchronization.

The design of each layer is described in detail below.

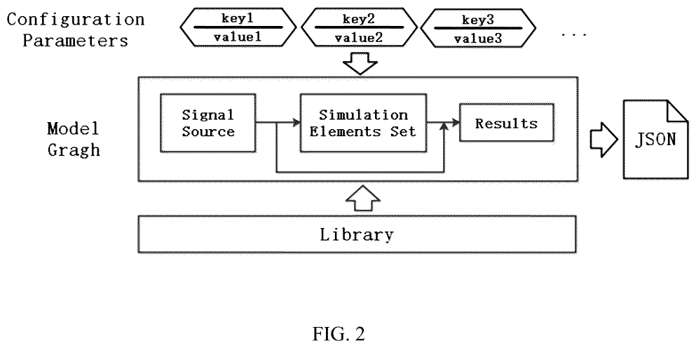

As for the system of the present disclosure, i.e., the plasma control system verification platform (PCS-VP), the framework of the system is modeled in a visual and modular mode, and the model may be constructed by visually dragging and connecting simulation elements. The presentation layer provides a visual modeling method for the framework through the interactive modeling environment and the parameter configuration component. As shown in FIG. 2, in the interactive modeling environment, a user may build a model graph by dragging modules and connecting lines from a model library view. The model graph is formed by combining and connecting a plurality of model blocks. After the modeling is completed, the model graph is stored in the form of a file, in which necessary simulation parameters such as input/output ports, connection relationships, and nested relationships between modules are recorded.

For many complex simulation models, the simulation parameters are larger and need to be calculated or read in advance, and cannot be directly represented by a character string, such as a matrix with a large number of rows and columns. In order to address this problem, the PCS-VP framework introduces a parameter configuration component that pre-reads or pre-processes parameters and writes the processed parameters into a common data pool. Since the mode of parameter processing is uncertain, as shown in FIG. 1, the parameter configuration component provides a code editor and a code execution environment to support the writing and perform a parameter preprocessing code. The obtained model configuration parameters are stored in the data pool in the form of a key-value pair. During the modeling, the user can pre-define a variable through the code editor and the execution environment, and then enter a variable name according to a format $ {name}. During the simulation, the simulation engine may read a variable in the data pool through the shared memory to perform the simulation.

The logic layer may include the simulation engine and the model library; and after the representation layer is determined, the logic and parameters of the model are simulated at the logic layer. The model graph file is analyzed by the simulation engine into the simulation model. The simulation engine may configure simulation information for the model including a simulation duration, a step, etc., and may provide a solver for a state space equation and a system transfer function in the model, control a simulation process and provide a message bus to support message passing among the engine, the model, and the block.

In the framework, the model is a set of simulation elements. According to the definition of the interface and method of the simulation module, the simulation engine is designed to complete the parameter configuration, simulation process control, module solving and log record of the model. The simulation engine may perform sort and an iterative operation according to a connection relationship of simulation modules, and output simulation data. In addition, the framework provides a solver for the calculation of the plasma state space equation; and when the simulation element is a state space equation or a transfer function, the simulation engine may enable the solver to solve.

The system library is a set of simulation elements with efficient and flexible management functions. The system library includes a basic library and a customization library. The basic library is a library provided by a platform for a basic operation and modeling; and the customization library is a function library constructed for the tokamak device. On the one hand, the existing conventional control algorithm models for the plasma control are customized, such as a poloidal field coil control model, a plasma position control model, and a plasma shape control model; and on the other hand, a plasma rigidity response model, a power supply model, and the like are integrated. With the customization library, a simple simulation of plasma control can be accomplished. By adjusting the simulation parameters or adding a more complex model, it is possible to adapt to plasma control simulation in different situations, which provides a reference for plasma discharge experiments. In addition, users can customize their own simulation elements in accordance with the interface specifications and add the simulation elements into the system library. The system library manages these third-party simulation elements through a tree structure; and when the simulation is performed, the simulation engine can load the corresponding simulation elements from the system library to complete the construction of the model.

As for the device layer, in order to provide support for better simulation verification for PCS and other subsystems, the system framework provides a hardware-in-loop (HIL) simulation scheme. The HIL connection is a good way to test the system hardware link, in which mode the PCS may shield a signal source to simulate the discharge. The hardware interaction provided by the framework is to build a hardware communication link to acquire data. The device layer in the framework may encapsulate a hardware driver, such as a reflective memory card, as a hardware simulation calling interface in the form of a customization library to the user.

The device layer includes a device manager in which status information of each hardware device is stored. On the one hand, it is ensured that one hardware device is invoked by only one interface module at the same time; and on the other hand, a plurality of devices can be monitored at the same time. In addition, the device manager includes a built-in channel wrapper to read mapping between a channel and data of each hardware device. After an external system to which the hardware device, such as a reflective memory card, is connected is determined, the user needs to define a data markup file including both channel numbers and signal names, so that the channel wrapper can obtain data through the signal name according to the file. When the connection of the hardware device changes, the device module can be used only by modifying the definition of the data markup file.

The device manager provides a simulation clock scheme in view of the fact that the hardware communication has the real-time performance and the computation of the simulation model cannot guarantee the real-time performance. A clock signal is provided by a simulation platform and shared by all hardware devices, the clock signal is added by one for each cycle. When the simulation data is updated, the simulation clock is read by the external system at the same time. When the clock signal changes, the external system starts to enter the next cycle, so that data asynchronization is avoided, and the calculation of the external system follows the simulation system.

According to the embodiments of the present disclosure, specific implementation modes are now described as follows. In the visual, modular modeling process, the model may be regarded as a set of computations, operations, and data channels. The basic computations, such as addition, subtraction, multiplication, division, integral, differential, and the like, and the basic operations, such as signal input/output, resolution and combination, are integrated as function units in the framework. These function units are referred to as simulation elements. The framework supports the modeling simulation of the plasma by representing, organizing, and scheduling simulation elements. Moreover, the simulation element is also a unified interface of the framework extension model. Therefore, the definition of the simulation element may be described first.

In order to ensure good extensibility of the framework and universality of the simulation elements, a standardized definition template of the simulation element is provided. In addition to the image representation, the simulation element is defined by two parts: a system class and a JSON template. As shown in Table 1, the system class is the definition of the simulation element at the logical level, which determines an arithmetic logic of the simulation element when the simulation is performed. As shown in Table 2, the JSON template is configured to define basic information of the simulation element such as a name, a type, a path, a shape, and a hierarchical structure of the system. The parameter information and port information of the simulation elements are also determined in the JSON template, which correspond to the member definitions in the system class. Accordingly, the simulation element in the logic layer is referred to as a system as an example, and the simulation element in the representation layer is referred to as a block as an example.

TABLE 1
definition of system class

| Member name | Functions |
|---|---|
| Dict input_ports[ ] | Saving dictionary of input port, and |
| | obtaining port value by port name |
| Dict output_ports[ ] | Saving dictionary of output port, and |
| | outputting port value by port name |
| Dict parameters[ ] | Saving module parameter values |
| Void set_parameter( ) | Setting system parameter, checking |
| | validity of parameter the and adjusting |
| | structure of the parameter |
| Void initialze( ) | Module initialization |
| Void update( ) | Updating module state |
| Void output( ) | Computing module output |
| Void terminate( ) | Module termination |

TABLE 2
definition of JSON, including following data items:

| Name | Functions |
|---|---|
| name | System name |
| type | System type |
| path | System path, with the format |
| | category.system_name |
| shape | Display shape of system |
| width | Width of system position |
| height | Height of system position |
| is_subsystem | Boolean type, indicating whether the system |
| | is a subsystem |
| is_atomic | Boolean type, indicating whether the system |
| | is an atomic subsystem. If is_subsystem is |
| | False, the field defaults to False |
| child_model | If it is a subsystem, the field corresponds to |
| | sub-model object corresponding to the |
| | subsystem, otherwise it is null |
| is_custom_in_ports | Whether it is a customized input port |
| is_custom_out_ports | Whether it is a customized output port |
| parameters | System parameter object |
| ports | Port dictionary |

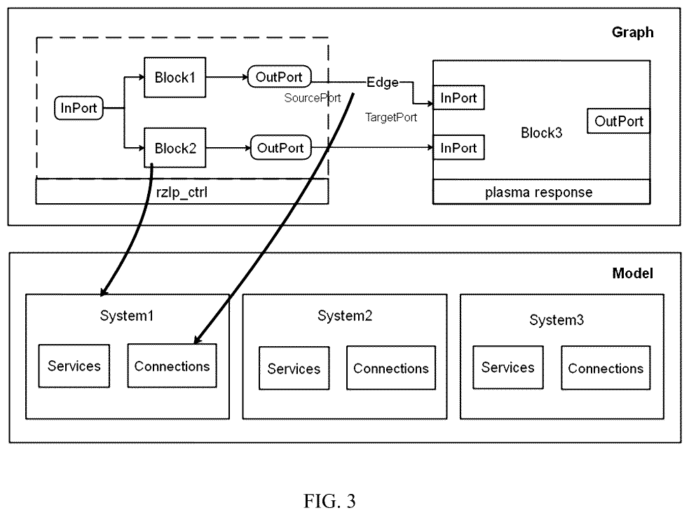

According to an embodiment of the present disclosure, the model is a set of simulation elements and data channels. In the modeling stage, a definition of a simulation element is provided, and modeling is to build data channels and hierarchical relationships between different simulation elements. FIG. 3 shows an example of modeling of a simple plasma control model. Each Block shown in the upper half of FIG. 3 is a simulation element. Edge denotes a data channel connecting another block. The plasma position control model is established as a subsystem consisting of a plurality of blocks, which, like the block, has input and output ports and is connected to the block corresponding to the plasma to perform the control.

When the simulation is performed, the model graph constructed by the block and edge may be mapped into the simulation engine, so that the framework may process the arithmetic logic of the block according to the data dependency of the block, as shown in FIG. 3. The hierarchical relationship of blocks are expanded, each block is analyzed into a system instance, and the data dependency is stored in the connections according to the sourcePort and targetPort connected to the edge. The parameter of the block are mapped through the data pool. FIG. 3 is a simple example of a plasma control model and a mapping rule thereof.

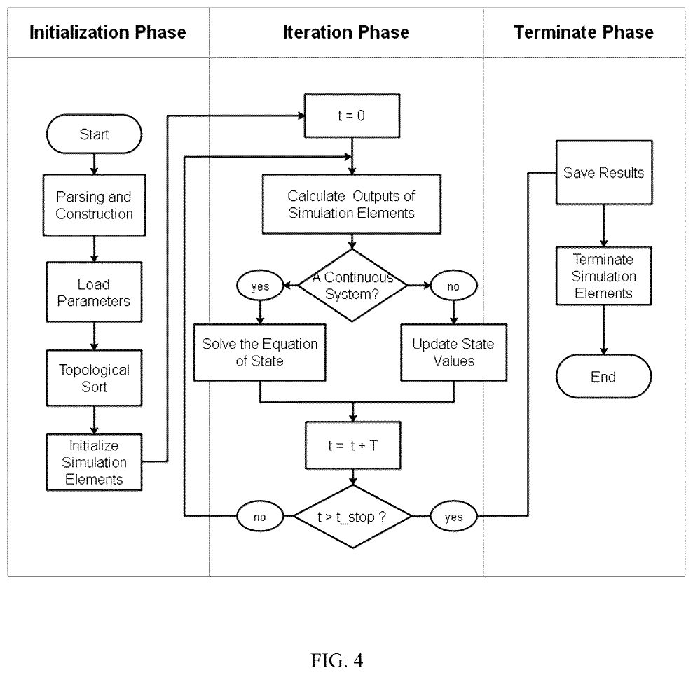

After the model graph is mapped to the logical layer, a set of blocks having a data dependency is obtained, which is referred to as a model in the present disclosure. As shown in FIG. 4, the simulation engine may process these blocks in three stages: an initialization stage, an iteration stage, and a termination stage. In the initialization stage, the simulation engine analyzes the model graph to construct the model and loads parameters of each bock from the data pool. The blocks are also topologically ordered according to the data dependencies. Thereafter, the blocks may be initialized so that a model that can perform the simulation computation is ready. In the iteration stage, the block may be iterated step by step until the simulation end time is reached. In each iteration cycle, the output of the block may be computed and inputted into the next block, and then the state variable of the current system is updated. For a discontinuous system, the update method can be invoked directly, but the continuous system needs to perform an equation solving operation through a solver in the simulation engine. At the end of the simulation, the result calculated by the model and the logs may be stored. Moreover, the termination method of the block is invoked to complete the ending work.

As for the customization module, based on the definitions of the above-mentioned basic framework and the simulation elements, the simulation verification platform customizes a related model library to help control the plasma, and customizes the hardware communication interface and the database-related interface to support the verification control system and the verification model, to provide a use interface for a machine learning-related model.

According to an embodiment of the present disclosure, a specific modeling simulation process of a plasma controller is provided as follows.

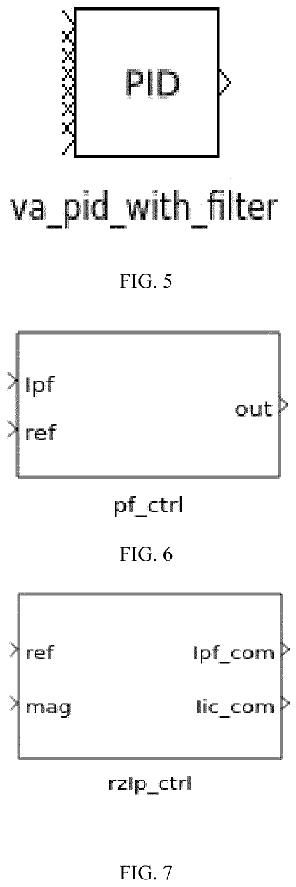

Firstly, a variable PID control model with a filter is customized, and PID control in EAST plasma control is widely applied. Unlike the PID controller in the conventional system, each item in the PID control is implemented by using a filter in order to reduce the noise of the signal. Moreover, the PID control parameter changes continuously at different stages of the plasma control. Accordingly, in the customization library of the framework, the present disclosure customizes the variable parameter PID module with the filter. As shown in FIG. 5, three parameters of the proportion, the integration and the differentiation, and the corresponding three filter parameters, and the error of the signal, i.e., total seven quantities, serve as inputs of the module, and the calculated PID command serves as the output. Thus, the six PID-related parameters may be inputted with varying waveforms to complete the variable PID.

The poloidal field coil current control model is customized, the poloidal field coil current control is the PID control of fourteen coil currents in the EAST tokamak, which plays an important role in position and shape controls of the plasma. As shown in FIG. 6, in the module, a control command of each control coil is calculated with a current of the current coil and a target current as inputs.

The RZIp control model is customized. The RZIp control is to perform the PID control on the EAST plasma position (a horizontal position R and a longitudinal position Z) and the plasma current Ip. Since the control still uses the poloidal field coil as an actuator, R, Z and Ip are decoupled into the current required on the coils after the PID calculation is performed on the R, Z and Ip in the model. At the moment, the control algorithm of the entire RZIp is completed by controlling the coil current, as shown in FIG. 7.

A data acquisition and processing model is configured to simulate the acquisition and preprocessing of a magnetic measurement signal. There are two preprocessing methods, one of which is to estimate by using an estimation matrix (Ematrix), and when the plasma position control is performed, the plasma position can be roughly estimated by multiplying a measurement signal by the Ematrix. This method is fast, but the estimation error is larger. The other method is to perform an equilibrium reconstruction by using an EFIT module, which provides information such as plasma boundaries, an X-point position error, a flux error at each control point, and the like.

An exception triggering and processing model is customized and is configured to simulate an exception event that may occur during the plasma operation. The exception triggering and processing model consists of three portions, i.e., an event scheduling component configured to set and issue an event waveform, an event generator and an event detector. The event generator generates an exception event according to the event waveform. Considering that any module may have an exception, there is an event generator in each module. The event detector is built into the controller and is configured to capture and process the exception by means of the measurement signal.

When the exception discharge scene is simulated, the event scheduling component transmits event information to the specified event generator. From the event information, the event generator generates an exception in a module in which the event generator is located. After the event detector captures the exception, the controller performs corresponding exception processing according to the event type.

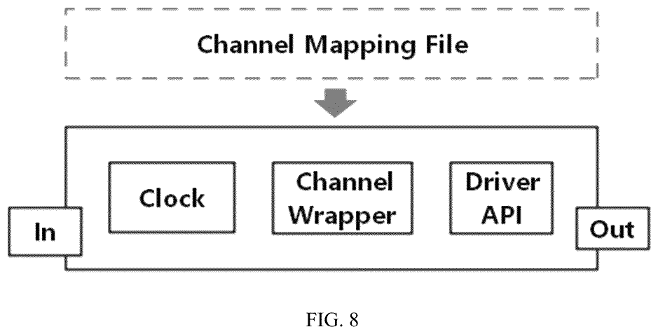

According to an embodiment of the present disclosure, the hardware closed-loop communication interface is designed as shown in FIG. 8, and the hardware communication interface is extended at the device layer based on the simulation elements. The hardware driver API is encapsulated in the interface to provide read and write functions for the data. Since the channel numbers of different hardware are different, the read and write positions of the signal are determined by the channel mapping file and the channel wrapper. For example, the communication with the PCS often requires 94 signals, and a sequence of the signals may be determined in the mapping file. The start and end positions of the signal read and write may be managed uniformly by the channel wrapper. In order to guarantee the synchronization of the data, each time the data is updated, the hardware communication interface may acquire a timer at the device layer to provide the clock information.

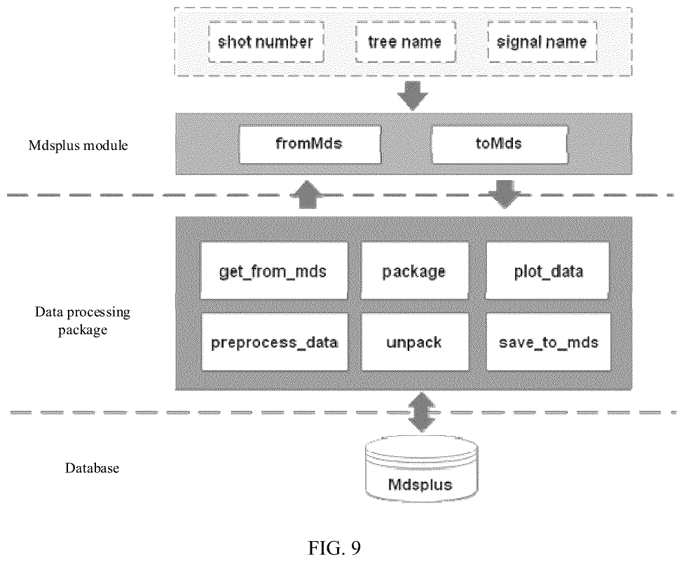

According to an embodiment of the present disclosure, the design of the database interface is shown in FIG. 9. In addition to the need to support the co-simulation with the PCS, the model often needs to be verified by experimental data. During the simulation test, the experimental data from the same shot may be used for many times, and it is time-consuming to connect the database to read and process the data at each test, and the database resource is occupied. Therefore, for such non-real-time data, the framework stores the acquired and processed data as a temporary data packet, so that only one operation of database reading and data processing is required during the simulation test. It should be noted that most of the historical data are timing data when the plasma discharges, and the frame may process the data into two-dimensional data with a time stamp when processing. As shown in the figures, with the data processing package, data is acquired and processed into timing data. Moreover, the data obtained and processed for the first time may be packaged and stored. When the data from the same shot is used again, the processed data can be directly unpacked and obtained.

Considering that different types of data have different retention rates in the database, and different data sources have different time axes. During the simulation, the fromMds module performs the interpolation operation on the historical data according to the simulation step to ensure the correctness of the data.

At the same time, the simulated data may be stored in the memory by the toMds. Through the database interface package, the simulation result can be analyzed and compared and stored in the database. In such a manner, it is only necessary to provide the database interface with a shot number, a MDSplus tree name, and a signal name needing to be acquired, the data in the database can be flexibly accessed.

While the above illustrative embodiments of the present disclosure are described to facilitate understanding of the present disclosure by those skilled in the art, it should be understood that the present disclosure is not limited to the specific embodiments, and that variations should be obvious to those of ordinary skill in the art as long as the variations fall within the spirit and scope of the disclosure as defined and determined by the appended claims, and all inventions using the concept of the present disclosure should be the protection scope of the present disclosure.

What is claimed is:

1. A modeling simulation system for plasma control, comprising:
an interactive modeling environment module and a parameter configuration component, configured to represent and construct a plasma control model and a response model;
a simulation engine, configured to invoke a calculation code of a simulation element or perform a simulation calculation by using a solver, and transmit calculated simulation results back to users;
a system library, comprising a basic library and a customization library; and
a device manager, configured to extend a communication interface by using the simulation element to support a communication between models and external systems and guarantee message synchronization.

2. The modeling simulation system for plasma control according to claim 1, wherein the interactive modeling environment module is constructed by visually dragging and connecting simulation elements, a user constructs a model graph by dragging and connecting modules from a model library view in the interactive modeling environment, the model graph is formed by combining and connecting a plurality of model blocks, and is stored as a file after the modeling is completed, simulation parameters between the modules are stored in the file, and comprise input/output ports, connection relationships, and nested relationships.

3. The modeling simulation system for plasma control according to claim 1, wherein the parameter configuration component is configured to pre-read or pre-process parameters, and write the pre-read or pre-processed parameters into a common data pool, the parameter configuration component is configured to provide a code editor and a code execution environment to support the writing and perform a parameter preprocessing code, and the obtained model configuration parameters are stored in the data pool in a form of a key-value pair; during the modeling, a user pre-defines a variable through the code editor and the execution environment and then enters a variable name according to a format; during the simulation, the simulation engine is configured to read the variable in the data pool through a shared memory to perform the simulation.

4. The modeling simulation system for plasma control according to claim 1, wherein,
the simulation engine is configured to configure simulation information for the model comprising a simulation duration and a step, provide a solver for state space equations and system transfer functions in the model, control a simulation process, and provide a message bus to support message passing among the simulation engine, the model, and a model block, and record simulation logs;
the simulation engine is configured to perform a sort and an iterative operation according to a connection relationship of the simulation modules, and output simulation data.

5. The modeling simulation system for plasma control according to claim 1, wherein the basic library is provided for basic operation and modeling, the customization library is a function library constructed for a tokamak device, and the customization library is configured to customize a control algorithm model, a data acquisition and processing model, an exception triggering and processing model for the plasma control, and integrate a device coil power supply model and a plasma response model.

6. The modeling simulation system for plasma control according to claim 1, wherein the device manager is configured to store status information of each hardware device to ensure that one hardware device is invoked by only one interface module at the same time, and monitor a plurality of devices at the same time; the device manager is provided with a built-in channel wrapper to read mapping information between a channel and data of each hardware device; the file saves the mapping information by recording the channel number and the signal name; when the connection of the hardware device changes, the device module is used only by modifying the definition of the file.

7. The modeling simulation system for plasma control according to claim 1, wherein the device manager provides a simulation clock scheme, a clock signal is provided by the simulation platform and shared by all hardware devices, the clock signal is added by one for each cycle; when the simulation data is updated, the simulation clock is read by the external system at the same time; when the clock signal changes, the external system starts to enter a next cycle, to avoid data asynchronization.
